(19) United States
(12) Patent Application Publication
(10) Pub. No.: US 2021/0266564 A1
(43) Pub. Date: Aug. 26, 2021

(54) IMAGE ENCODING APPARATUS AND IMAGE ENCODING METHOD

(71) Applicant: SHARP KABUSHIKI KAISHA, Sakai City (JP)

(72) Inventor: HIROYUKI HAYASHI, Sakai City (JP)

(21) Appl. No.: 17/179,880

(22) Filed: Feb. 19, 2021

(30) Foreign Application Priority Data
Feb. 20, 2020 (JP) 2020-026696

(51) Int. Cl. H04N 19/159; H04N 19/105; H04N 19/12; H04N 5/232; H04N 5/247

(52) U.S. Cl. CPC H04N 19/159; H04N 19/105; H04N 5/247; H04N 5/23299; H04N 19/12

(57) ABSTRACT

An image encoding apparatus comprising: a receiving unit that receives, from another image encoding apparatus, a first instruction for encoding using a type of reference picture; a determining unit that determines whether or not an image to be encoded, is to be encoded using the reference picture type; an encoding unit that generates a reference picture to perform intra-frame prediction encoding on the image to be encoded, when the receiving unit receives the first instruction, or when the determining unit determines that the image to be encoded is to be encoded using the reference picture type; and a transmitting unit that transmits a second instruction for encoding using the reference picture type to the other image encoding apparatus, when the determining unit determines that the image to be encoded is to be encoded using the reference picture type.

### BACKGROUND

### 1. Field

The present disclosure relates to an image encoding apparatus and an image encoding method.

### 2. Description of the Related Art

A technology for outputting an image stream that can be promptly played back and be easily edited in the middle of the image stream without compromising the encoding efficiency has been known (e.g., see Japanese Unexamined Patent Application Publication No. 2006-340001).

Also, a technology that creates a scene including a facial expression, such as a smiley face or a crying face, as a reference frame to allow prompt playback and easy editing while suppressing a reduction in encoding efficiency has been known (e.g., see Japanese Unexamined Patent Application Publication No. 2010-161740).

For example, H.264/MPEG-4 AVC has been known as a video encoding system. Picture types used in H.264/MPEG-4 AVC include an intra-coded picture (I picture) encoded using only information in the same screen, a predicted picture (P picture) encoded using differences from a temporally previous picture, and a bidirectionally predicted picture (B picture) that can use both differences from a temporally previous picture and differences from a temporally subsequent picture. Also, a limited I picture called an instantaneous decoder refresh (IDR) picture is available. The IDR picture prohibits referencing to any picture before the IDR picture as a reference image. A case in which the IDR picture is used as the I picture will be described below.

For example, for playing back video data encoded with H.264/MPEG-4 AVC, the video data needs to be decoded starting from an IDR picture that does not perform inter-frame reference. For example, for playback (decoding) at a certain time point in the middle of the video data, when a picture at the certain time point is an IDR picture, the playback can be started from a portion at the certain time point. However, when the picture at the certain time point is not an IDR picture, a closest IDR picture that is prior to the certain time point or a closest IDR picture that is subsequent to the certain time point is searched for, and the found IDR picture is first played back. Hence, when a picture at a designated time point is not an IDR picture, an IDR picture that is prior or subsequent to the time point is first decoded. This also applies to a case in which editing, such as deleting a (temporally) unwanted portion from encoded video data, is performed.

FIG. 1 is a diagram illustrating an example of known video editing.

It is assumed that, for example, an identical subject is simultaneously shot from different angles by two cameras (a first camera and a second camera), and there are two pieces of video data acquired by the respective cameras and encoded, as illustrated in FIG. 1. The upper stage in FIG. 1 indicates first video data acquired by the first camera and encoded, and the middle stage indicates second video data acquired by the second camera and encoded. In the video data in FIG. 1, a portion corresponding to an IDR picture is denoted by IDR, and the type of picture at each portion that is not particularly denoted is a P picture or B picture.

In video editing, for creating one piece of video data by editing two pieces of video data, when switching is performed from the first video data to the second video data at time point t1, the picture at time point t1 in the second video data is not usable from time point t1, since the picture is not an IDR picture, and thus playback (decoding) is performed starting from the IDR picture at time point t2 subsequent to time point t1. Thus, in edited video data illustrated at the lower stage in FIG. 1, the second video data from time point t1 to time point t2 is not used, and in the edited video data, the second video data from time point t2 is joined to the end of the first video data from time point t0 to time point t1. Hence, in the edited video data, the second video data from time point t2 is played back after the first video data from time point t0 to time point t1 is played back.

Similarly, when switching is performed from the second video data to the first video data at time point t3, the picture at time point t3 in the first video data is not usable since the picture is not an IDR picture, and playback (decoding) is performed starting from an IDR picture at time point t4 subsequent to time point t3. In the edited video data illustrated at the lower stage in FIG. 1, the first video data from time point t3 to time point t4 is not used. Hence, in the edited video data, the first video data from time point t4 is played back after the second video data from time point t2 to time point t3 is played back.

As in the edited video data in FIG. 1 the portion from time point t1 to time point t2 and the portion from time point t3 to time point t4, the portions being included in two pieces of video data that are edit sources, are lost from the edited video data.

For creating one piece of video data by editing two pieces of video data without re-encoding, as described above, there are cases in which time points before and after an edit point that is a coupling portion of the two pieces of video data become discontinuous.

Video data in which time points are continuous before and after an edit point can be obtained by decoding video data during video editing and re-encoding the resulting video data using a picture type (e.g., an IDR picture type) that does not perform inter-frame reference. For example, in the second video data in FIG. 1, when an IDR picture prior to time point t1 is first decoded, and the decoded video data is re-encoded using an IDR picture type, the second video data from time point t1 can be used for the edited video data. In this case, however, since both the decoding and the encoding are performed, there is a problem in that the processing cost increases.

It is desirable to perform encoding that makes it easy to create video data in which time points are continuous before and after an edit point during editing without re-encoding.

### SUMMARY

According to an aspect of the disclosure, there is provided an image encoding apparatus that encodes a plurality of input images. The image encoding apparatus includes: a receiving unit that receives, from another image encoding apparatus, a first instruction for encoding using a type of reference picture that prohibits referencing to any reference image before the reference picture in inter-frame prediction encoding; a determining unit that determines whether or not an image to be encoded, the image being included in the plurality of input images, is to be encoded using the reference picture type; an encoding unit that generates a reference picture by using a predetermined coding system to perform intra-frame prediction encoding on the image to be encoded, when the receiving unit receives the first instruction, or when the determining unit determines that the image to be encoded is to be encoded using the reference picture type; and a transmitting unit that transmits a second instruction for encoding using the reference picture type to the other image encoding apparatus, when the determining unit determines that the image to be encoded is to be encoded using the reference picture type.

According to an aspect of the disclosure, there is provided an image encoding apparatus that encodes a plurality of first input images and a plurality of second input images. The image encoding apparatus includes: a determining unit that determines whether or not a first image to be encoded, the first image being included in the plurality of first input images, is to be encoded using a type of reference picture that prohibits referencing to a reference image before the reference picture in inter-frame prediction encoding, and that determines whether or not a second image to be encoded, the second image being included in the plurality of second input images, is to be encoded using the reference picture type; a first encoding unit that generates a reference picture by using a predetermined coding system to perform intra-frame prediction encoding on the first image to be encoded, when the determining unit determines that the first image to be encoded is to be encoded using the reference picture type, or when the determining unit determines that the second image to be encoded is to be encoded using the reference picture type; and a second encoding unit that generates a reference picture by using a predetermined coding system to perform intra-frame prediction encoding on the second image to be encoded, when the determining unit determines that the second image to be encoded is to be encoded using the reference picture type, or when the determining unit determines that the first image to be encoded is to be encoded using the reference picture type.

According to an aspect of the disclosure, there is provided an image encoding method for an image encoding apparatus that encodes a plurality of input images. The image encoding method includes: receiving, from another image encoding apparatus, a first instruction for encoding using a type of reference picture that prohibits referencing to any reference image before the reference picture in inter-frame prediction encoding; determining whether or not an image to be encoded, the image being included in the plurality of input images, is to be encoded using the reference picture type; generating a reference picture by using a predetermined coding system to perform intra-frame prediction encoding on the image to be encoded, when the first instruction is received, or when it is determined that the image to be encoded is to be encoded using the reference picture type; and transmitting a second instruction for encoding using the reference picture type to the other image encoding apparatus, when it is determined that the image to be encoded is to be encoded using the reference picture type.

According to an aspect of the disclosure, there is provided an image encoding method for an image encoding apparatus that encodes a plurality of first input images and a plurality of second input images. The image encoding method includes: determining whether or not a first image to be encoded, the first image being included in the plurality of first input images, is to be encoded using a type of reference picture that prohibits referencing to a reference image before the reference picture in inter-frame prediction encoding; determining whether or not a second image to be encoded, the second image being included in the plurality of second input images, is to be encoded using the reference picture type; generating a reference picture by using a predetermined coding system to perform intra-frame prediction encoding on the first image to be encoded, when it is determined that the first image to be encoded is to be encoded using the reference picture type, or when it is determined that the second image to be encoded is to be encoded using the reference picture type; and generating a reference picture by using a predetermined coding system to perform intra-frame prediction encoding on the second image to be encoded, when it is determined that the second image to be encoded is to be encoded using the reference picture type, or when it is determined that the first image to be encoded is to be encoded using the reference picture type.

### BRIEF DESCRIPTION OF THE DRAWINGS

FIG. 1 is a diagram illustrating an example of known video editing;

FIG. 2 is a block diagram illustrating an example of the configuration of an image encoding system according to a first embodiment;

FIG. 3 is a flowchart illustrating one example of an image encoding method according to the first embodiment;

FIG. 4 is a sequence diagram illustrating one example of the image encoding method according to the first embodiment;

FIG. 5 is a diagram illustrating an example of video editing using video data according to the first embodiment;

FIG. 6 is a block diagram illustrating one example of an image encoding apparatus according to a second embodiment; and

FIG. 7 is a flowchart illustrating one example of an image encoding method according to the second embodiment.

### DESCRIPTION OF THE EMBODIMENTS

Embodiments will be described below with reference to the accompanying drawings. The same or equivalent elements in the drawings are denoted by the same reference numerals, and redundant descriptions are not given hereinafter.

### First Embodiment

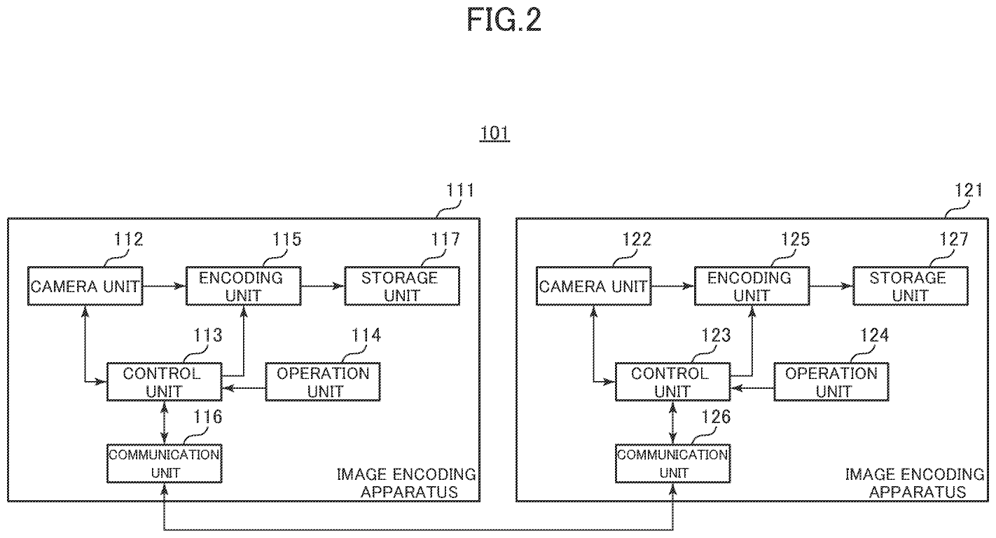

FIG. 2 is a block diagram illustrating an example of the configuration of an image encoding system according to a first embodiment.

An image encoding system 101 includes image encoding apparatuses 111 and 121. The image encoding apparatuses 111 and 121 can communicate with each other. The number of image encoding apparatuses is not limited to two and may be three or more.

The image encoding apparatus 111 includes a camera unit 112, a control unit 113, an operation unit 114, an encoding unit 115, a communication unit 116, and a storage unit 117. The image encoding apparatus 121 includes a camera unit 122, a control unit 123, an operation unit 124, an encoding unit 125, a communication unit 126, and a storage unit 127. Each of the image encoding apparatuses 111 and 121 is an apparatus that can shoot video and is, for example, a video camera, a smartphone, or a personal computer (PC).

The camera unit 112 shoots a subject and outputs un-compressed image data to the control unit 113 and the encoding unit 115. Specifically, for example, the camera unit 112 includes a lens, an imaging unit (e.g., a charge-coupled device (CCD) or a complementary metal-oxide semiconductor (CMOS)), an analog-to-digital (A/D) converter, and a signal processor. The imaging unit in the camera unit 112 receives subject light that is incident through the lens, converts resulting subject light into electrical analog signals, outputs the analog signals to the A/D converter, which converts the analog signals into digital signals and outputs the digital signals to the signal processor. The signal processor performs processing, such as gamma correction and white balance correction, on the digital signals input from the A/D converter, to generate un-compressed image data and outputs the un-compressed image data to the control unit 113 and the encoding unit 115. The camera unit 112 periodically (e.g., every 1/30 second) outputs the un-compressed image data to the control unit 113 and the encoding unit 115. The camera unit 112 may be provided external to the image encoding apparatus 111.

The control unit 113 controls the camera unit 112. For example, based on a user's input to the operation unit 114, the control unit 113 controls the camera unit 112 to perform pan, tilt, zoom, autofocus, or the like. In addition, the control unit 113 transmits an instruction for encoding using an IDR picture type to the image encoding apparatus 121 via the communication unit 116.

In addition, the control unit 113 controls encoding processing in the encoding unit 115. Specifically, for example, during encoding processing in the encoding unit 115, the control unit 113 determines a picture type (e.g., an IDR picture type, a P picture type, or a B picture type) and issues an instruction indicating (designating) the determined picture type. Specifically, for example, the control unit 113 determines that the encoding is to be performed using the IDR picture type periodically (e.g., every 1 second) or at the time of starting or ending of pan, tilt, zoom, or autofocus of the camera unit 112 and issues an instruction for encoding using the IDR picture type to the encoding unit 115. Also, for example, upon determining that the encoding is not to be performed using the IDR picture type, the control unit 113 issues an instruction for encoding using a non-IDR picture type (the P picture type or B picture type) to the encoding unit 115. For example, when the communication unit 116 receives an instruction for encoding using the IDR picture type from the image encoding apparatus 121, the control unit 113 issues an instruction for encoding using the IDR picture type to the encoding unit 115. For example, by monitoring the communication unit 116 or by receiving, from the communication unit 116, a notification indicating that an instruction for encoding using the IDR picture type is received from the image encoding apparatus 121, the control unit 113 determines whether or not the communication unit 116 receives an instruction for encoding using the IDR picture type from the image encoding apparatus 121. The control unit 113 is one example of a determining unit.

The operation unit 114 receives an input, performed by the user, for performing an operation on the image encoding apparatus 111, an operation on the camera unit 112, data input to the image encoding apparatus 111, or the like. Examples of the operation unit 114 include a touch panel, a push-button, and a switch.

Based on the instruction from the control unit 113, the encoding unit 115 uses a predetermined coding system to encode the un-compressed image data (input images) input from the camera unit 112. Specifically, for example, upon receiving the instruction for encoding using the IDR picture type from the control unit 113 (when the control unit 113 determines that the encoding is to be performed using the IDR picture type, or when the communication unit 116 receives the instruction for encoding using the IDR picture type from the image encoding apparatus 121), the encoding unit 115 generates an IDR picture by using the predetermined coding system to perform intra-frame prediction encoding (intra-coding) on the un-compressed image data input from the camera unit 112. Also, for example, upon receiving an instruction for encoding using the non-IDR picture type from the control unit 113, the encoding unit 115 generates a P picture or B picture by using the predetermined coding system to perform inter-frame prediction encoding (inter-coding) on the un-compressed image data input from the camera unit 112. The encoding unit 115 then stores, in the storage unit 117, video data (an encoded bit stream) including the IDR picture, the P picture, and the B picture generated by the encoding. The predetermined coding system used by the encoding unit 115 is a coding system that can use the IDR picture type and is, for example, H.264/MPEG-4 AVC (hereinafter, H.264) or H.265/MPEG-H HEVC (hereinafter, H.265). The IDR picture type is also one example of a type of reference picture that prohibits referencing to any reference image before the reference picture in inter-frame prediction encoding.

The communication unit 116 receives the instruction for encoding using the IDR picture type from the image encoding apparatus 121. Also, based on a determination result of the control unit 113, the communication unit 116 transmits the instruction for encoding using the IDR picture type to the image encoding apparatus 121. The communication unit 116 is one example of a receiving unit and a transmitting unit.

The storage unit 117 stores therein a program and data used by the image encoding apparatus 111, data generated by the image encoding apparatus 111, and so on. The storage unit 117 stores therein the video data (the encoded bit stream) generated by the encoding unit 115. The storage unit 117 is, for example, a storage device, such as a flash memory or a hard disk drive (HDD). The storage unit 117 may also be a portable recording medium, such as a Secure Digital (SD) memory card or a Universal Serial Bus (USB) memory.

The image encoding apparatus 111 may further include a display unit that displays an image acquired by the camera unit 112 and the video data stored in the storage unit 117.

Since functions of the camera unit 122, the control unit 123, the operation unit 124, the encoding unit 125, the communication unit 126, and the storage unit 127 in the image encoding apparatus 121 are substantially the same as the corresponding functions of the camera unit 112, the control unit 113, the operation unit 114, the encoding unit 115, the communication unit 116, and the storage unit 117, descriptions thereof are not given below.

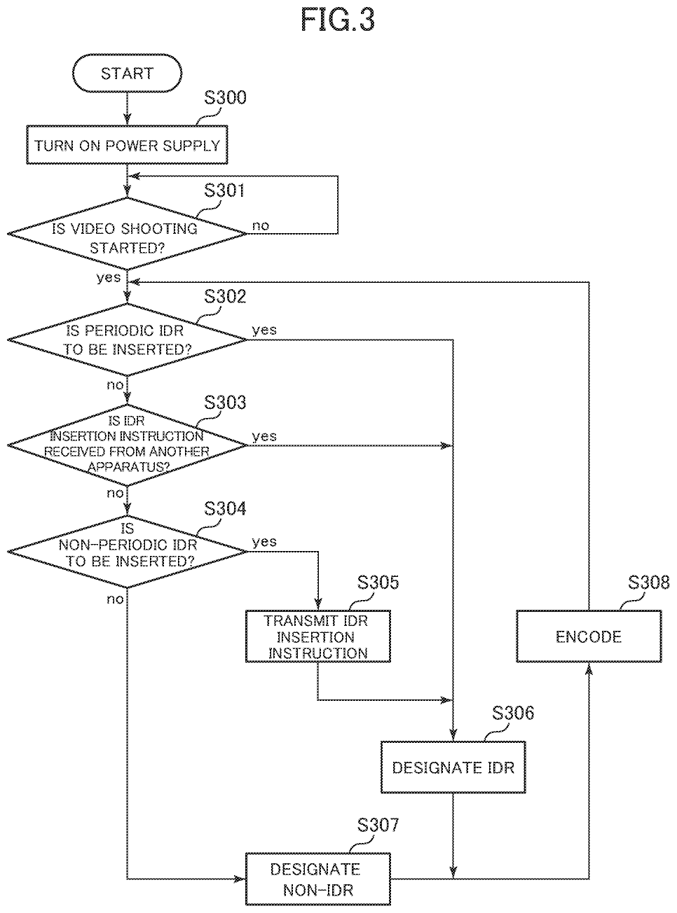

FIG. 3 is a flowchart illustrating one example of an image encoding method according to the first embodiment. Now, a description will be given of processing in the image encoding apparatus 111. Since processing in the image encoding apparatus 121 is substantially the same as the processing in the image encoding apparatus 111, a description thereof is not given below.

In step S300, a user operates the operation unit 114 to turn on a power supply of the image encoding apparatus 111. In response, the camera unit 112, the control unit 113, and so on start operations to allow video shooting. Although not illustrated in the flowchart in FIG. 3, the control unit 113 performs control (e.g., zoom, pan, or tilt) on the camera unit 112, as appropriate, in accordance with the user's operation on the operation unit 114.

In step S301, the control unit 113 determines whether or not video shooting is started. When the control unit 113 determines that video shooting is started, the control proceeds to step S302. For example, when the user operates the operation unit 114 to perform a video shooting start operation, the control unit 113 detects the video shooting start operation on the operation unit 114 (Yes in step S301) and controls the camera unit 112 and the encoding unit 115 to start video shooting. Thus, the encoding unit 115 starts encoding using the predetermined coding system on the un-compressed image data input from the camera unit 112. The control unit 113 may also send a notification indicating a video shooting start timing to the image encoding apparatus 121 via the communication unit 116 to synchronize the video shooting start timing of the image encoding apparatus 111 and the video shooting start timing of the image encoding apparatus 121 (specifically, the encoding timing of the image encoding apparatus 111 and the encoding timing of the image encoding apparatus 121). This makes it possible to suppress mismatch between the encoding timing of an IDR picture encoded by the image encoding apparatus 111 and the encoding timing of an IDR picture encoded by the image encoding apparatus 121. The following description will be given of processing of an image that is to be encoded (an image to be encoded), the image being included in pieces of un-compressed image data that are input.

In step S302, the control unit 113 determines whether or not the image to be encoded is to be encoded using a periodic IDR picture type. Specifically, for example, the control unit 113 determines that the image to be encoded is to be periodically (e.g., every 1 second) encoded using the IDR picture type. When the control unit 113 determines that the image to be encoded is to be encoded using the periodic IDR picture type (Yes in step S302), the control proceeds to step S306. When the control unit 113 determines that the image to be encoded is not to be encoded using the periodic IDR picture type (No in step S302), the control proceeds to step S303. Also, while the camera unit 112 is zooming, panning, or tilting, the control unit 113 may increase the intervals of periodic IDR pictures, compared with a case in which the camera unit 112 is not zooming, panning, or tilting. When the number of IDR pictures increases, the encoding efficiency decreases. Thus, when the interval between the current time point and a time at which a most-recent non-periodic IDR picture was encoded is smaller than or equal to a predetermined amount of time, the control unit 113 does not necessarily have to determine that the encoding is to be performed using the periodic IDR picture type.

In step S303, the control unit 113 determines whether or not the communication unit 116 receives an instruction for encoding using the IDR picture type from another image encoding apparatus (e.g., the image encoding apparatus 121) in a period from the process in step S303 performed last time until the process in step S303 performed this time (or a period from step S301 until the process in step S303, when step S303 is performed for the first time). When the control unit 113 determines that the communication unit 116 receives an instruction for encoding using the IDR picture type from the other image encoding apparatus 121 in the above-described period (Yes in step S303), the control proceeds to step S306. When the control unit 113 determines that the communication unit 116 does not receive an instruction for encoding using the IDR picture type from the other image encoding apparatus 121 in the above-described period (No in step S303), the control proceeds to step S304.

In step S304, the control unit 113 determines whether or not encoding using a non-periodic IDR picture type is to be performed. For example, based on control on the camera unit 112, the control unit 113 determines whether or not encoding using the non-periodic IDR picture type is to be performed. Specifically, for example, the control unit 113 determines that encoding using the IDR picture type is to be performed at the time of starting or ending of zoom of the camera unit 112, at the time of starting or ending of pan of the camera unit 112, or at the time of starting or ending of tilt of the camera unit 112. Also, for example, the control unit 113 may determine that encoding using the IDR picture type is to be performed at the time of starting or ending of autofocus of the camera unit 112. The control unit 113 may also determine whether or not encoding using a non-periodic IDR picture type is to be performed, for example, based on the input image input from the camera unit 112. Specifically, for example, the control unit 113 may determine that encoding is to be performed using the IDR picture type at the time of starting or ending of a section in which the input image is determined to have a good image composition, at the time of starting or ending of a section in which a subject in the input image speaks, or the like. The image having a good image composition is, for example, an image acquired by a professional photographer, and for example, the control unit 113 determines whether or not an input image at each time point has a good image composition by machine-learning images acquired by professional photographers. When the control unit 113 determines that the encoding is to be performed using the non-periodic IDR picture type (Yes in step S304), the control proceeds to step S305, and when the control unit 113 determines that the encoding is not to be performed using the non-periodic IDR picture type (No in step S304), the control proceeds to step S307.

In step S305, the control unit 113 transmits an instruction for encoding using the IDR picture type to the other image encoding apparatus (e.g., the image encoding apparatus 121) via the communication unit 116.

In step S306, the control unit 113 issues an instruction for encoding using the IDR picture type to the encoding unit 115 (“Designate IDR”).

In step S307, the control unit 113 issues an instruction for encoding using the non-IDR picture type (the P picture type or B picture type) to the encoding unit 115 (Designate Non-IDR).

In step S308, based on the instruction issued from the control unit 113 in step S306 or S307, the encoding unit 115 uses the predetermined coding system (e.g., H.264 or H.265) to encode the un-compressed image data (the input image) input from the camera unit 112. Specifically, for example, upon receiving the instruction for encoding using the IDR picture type from the control unit 113, the encoding unit 115 generates an IDR picture by using the predetermined coding system to perform intra-frame prediction encoding (intra-coding) on the un-compressed image data input from the camera unit 112. Also, for example, upon receiving the instruction for encoding using the non-IDR picture type from the control unit 113, the encoding unit 115 generates a P picture or B picture by using the predetermined coding system to perform inter-frame prediction encoding (inter-coding) on the un-compressed image data input from the camera unit 112. Then, the control returns to step S302, next un-compressed image data that is encoded after the image encoded in step S308 is set for a new image to be encoded, and the processes in steps S302 to S308 are repeated until there is no image data for an image to be encoded.

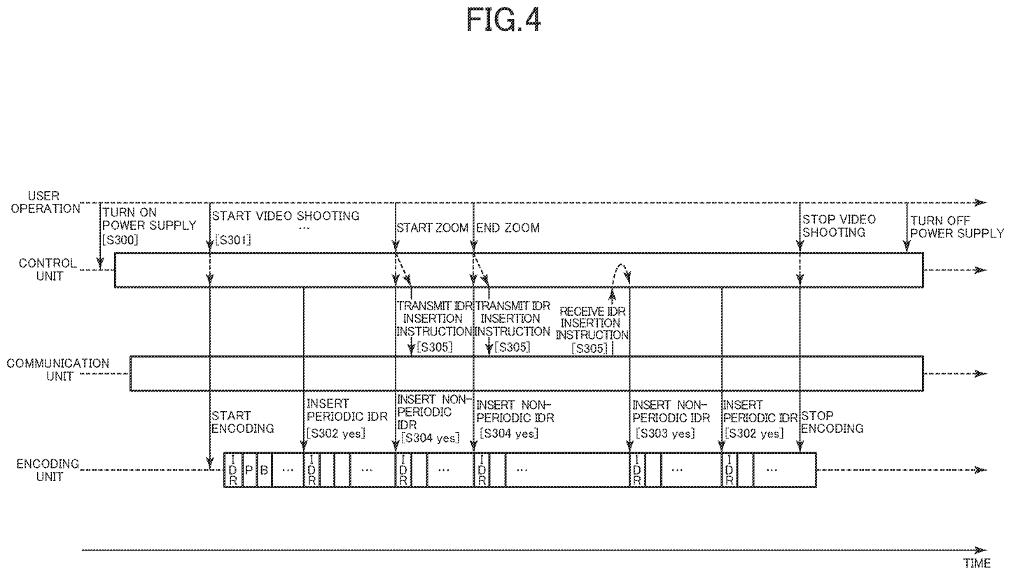

FIG. 4 is a sequence diagram illustrating one example of the image encoding method according to the first embodiment. FIG. 4 illustrates user operation, the control unit 113, the communication unit 116, video data encoded by the encoding unit 115 in order from top to bottom. In the encoded video data illustrated in FIG. 4, IDR represents the IDR picture, P represents the P picture, and B represents the B picture.

First, the user operates the operation unit 114 to turn on the power supply of the image encoding apparatus 111 (step S300). In response, the camera unit 112, the control unit 113, and so on start operations to allow video shooting.

When the user operates the operation unit 114 to perform a video shooting start operation, the control unit 113 detects the video shooting start operation on the operation unit 114 (Yes in step S301) and controls the camera unit 112 and the encoding unit 115 to start video shooting. Thus, the encoding unit 115 starts encoding using the predetermined coding system on un-compressed image data input from the camera unit 112. The encoded video data illustrated in FIG. 4 are an IDR picture, a P picture, and a B picture, . . . in that order from the beginning.

The control unit 113 determines that the image to be encoded is to be encoded using the periodic (e.g., every 1 second) IDR picture type (Yes in step S302). Thus, by using the IDR picture type, the encoding unit 115 generates an IDR picture by encoding the image to be encoded.

Zoom of the camera unit 112 is started in accordance with the user's operation on the operation unit 114, the control unit 113 determines that the encoding is to be performed using the non-periodic IDR picture type (Yes in step S304) and issues an instruction for encoding using the IDR picture type to the encoding unit 115. Thus, by using the IDR picture type, the encoding unit 115 generates an IDR picture by encoding the image to be encoded.

In addition, the control unit 113 transmits an instruction for encoding using the IDR picture type to the image encoding apparatus 121 via the communication unit 116 (step S305).

Thereafter, the zoom of the camera unit 112 is ended in accordance with the user's operation on the operation unit 114, the control unit 113 determines that the encoding is to be performed using the non-periodic IDR picture type (Yes in step S304) and issues an instruction for encoding using the IDR picture type to the encoding unit 115. Thus, by using the IDR picture type, the encoding unit 115 generates an IDR picture by encoding the image to be encoded.

Then, the communication unit 116 receives an instruction for encoding using the IDR picture type from the image encoding apparatus 121. In response, the control unit 113 determines that the communication unit 116 receives the instruction for encoding using the IDR picture type from the other image encoding apparatus 121 (Yes in step S303) and issues an instruction for encoding using the IDR picture type to the encoding unit 115. Thus, by using the IDR picture type, the encoding unit 115 generates an IDR picture by encoding the image to be encoded.

When a predetermined time (e.g., 1 second) passes after determining that the encoding is to be performed using the periodic IDR picture type, the control unit 113 re-determines that an image to be encoded is to be encoded using the periodic IDR picture type (Yes in step S302). Thus, by using the IDR picture type, the encoding unit 115 generates an IDR picture by encoding the image to be encoded.

Thereafter, a video shooting stopping operation is performed in accordance with the user's operation on the operation unit 114, and the control unit 113 stops the encoding processing performed by the encoding unit 115. Then, when the power supply of the image encoding apparatus 111 is turned off in accordance with the user's operation on the operation unit 114, the control unit 113 turns off the power supply of the image encoding apparatus 111.

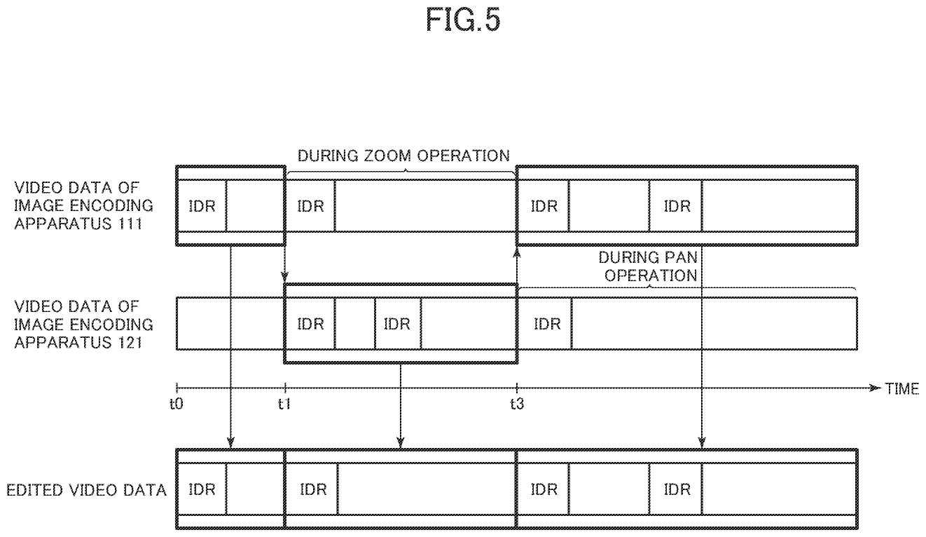

FIG. 5 is a diagram illustrating an example of video editing using video data according to the first embodiment.

For example, it is assumed that an identical subject is simultaneously shot from different angles by the camera unit 112 in the image encoding apparatus 111 and the camera unit 122 in the image encoding apparatus 121, and there are two pieces of video data encoded by the respective encoding devices 111 and 121. The upper stage in FIG. 5 represents first video data encoded by the image encoding apparatus 111, the middle stage represents second video data encoded by the image encoding apparatus 121, and the lower stage represents edited video data.

For example, at time point t1, since the camera unit 112 in the image encoding apparatus 111 starts zooming, a non-periodic IDR picture is generated in the first video data. Correspondingly, an instruction for encoding using the IDR picture type is transmitted from the image encoding apparatus 111 to the image encoding apparatus 121, and thus, at time point t1, an IDR picture is generated in the second video data encoded by the image encoding apparatus 121.

Similarly, at time point t3, since the camera unit 122 in the image encoding apparatus 121 starts panning, a non-periodic IDR picture is generated in the second video data. Correspondingly, an instruction for encoding using the IDR picture type is transmitted from the image encoding apparatus 121 to the image encoding apparatus 111, and thus, at time point t3, an IDR picture is also generated in the first video data encoded by the image encoding apparatus 111.

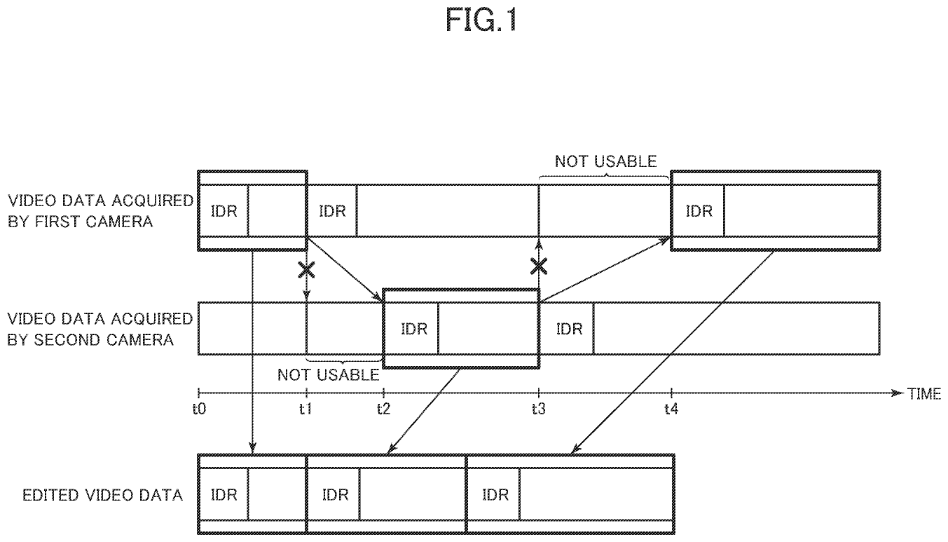

It is now assumed that angle switching editing for switching to the image acquired by the camera unit 122 is performed during zoom of the camera unit 112, as in FIG. 1. When switching is performed from the first video data to the second video data at time point t1 in the video editing, the second video data is played back (decoded) starting from the IDR picture at time point t1, since the picture at time point t1 in the second video data is the IDR picture.

Thus, in the edited video data illustrated at the lower stage in FIG. 5, the second video data from time point t1 is joined to the end of the first video data from time point t0 to time point t1. Hence, in the edited video data, the second video data from time point t1 is played back after the first video data from time point t0 to time point t1 is played back.

Similarly, when switching is performed from the second video data to the first video data at time point t3, the picture at time point t3 in the first video data is first played back (decoded), since the picture at time point t3 in the first video data is the IDR picture. In the edited video data illustrated at the lower stage in FIG. 5, the first video data from time point t3 is played back after the second video data from time point t1 to time point t3 is played back.

For creating one piece of video data by editing two pieces of video data, use of two pieces of video data in which time points of IDR pictures are the same makes it easy to create video data in which the time points are continuous before and after an edit point.

In the known video editing described above and illustrated in FIG. 1, when editing for switching from the first video data to the second video data at time point t1 is performed, the second video data from time point t1 to time point t2 is not usable in the edited video data, and thus video data in which time points before and after an edit point are discontinuous is created.

On the other hand, the image encoding system 101 in the first embodiment can create video data in which time points are continuous before and after an edit point without re-encoding, as illustrated in FIG. 5.

According to the image encoding system 101 in the first embodiment, time points of non-periodic IDR pictures in video data encoded by one apparatus and time points of non-periodic IDR pictures in video data encoded by another apparatus can be made to match each other. This makes it easy to create a piece of video data in which time points are continuous before and after an edit point in edited video data, when pieces of video data are edited into the piece of video data by combining.

### Second Embodiment

Although two image encoding apparatuses 111 and 121 perform encoding in the first embodiment, a case in which one image encoding apparatus including two camera units performs encoding will be described in a second embodiment.

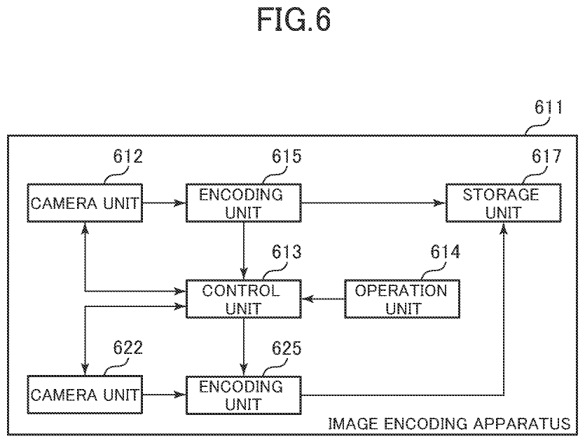

FIG. 6 is a block diagram illustrating one example of the configuration of an image encoding apparatus according to the second embodiment.

An image encoding apparatus 611 includes camera units 612 and 622, a control unit 613, an operation unit 614, encoding units 615 and 625, and a storage unit 617. The image encoding apparatus 611 is an apparatus that can shoot video and is, for example, a video camera, a smartphone, or a PC.

The camera unit 612 shoots a subject and outputs un-compressed image data to the control unit 613 and the encoding unit 615. The camera unit 622 shoots a subject and outputs un-compressed image data to the control unit 613 and the encoding unit 625. Since detailed functions and configurations of the camera units 612 and 622 are substantially the same as the functions and the configuration of the camera unit 112 described above, descriptions thereof are not given below. The camera units 612 and 622 can shoot respective ranges that differ from each other. For example, one of the camera units 612 and 622 has a standard lens, and the other has a wide-angle lens. Also, for example, one of the camera units 612 and 622 may have a telephoto lens, and the other may have a standard lens (or a wide-angle lens). The camera unit 612 periodically (e.g., every 1/30 second) outputs un-compressed image data to the control unit 613 and the encoding unit 615. The camera unit 622 periodically (e.g., every 1/30 second) outputs un-compressed image data to the control unit 613 and the encoding unit 625.

The control unit 613 controls the camera units 612 and 622. For example, based on a user's input to the operation unit 114, the control unit 613 controls each of the camera units 612 and 622 to perform pan, tilt, zoom, autofocus, or the like.

In addition, the control unit 613 controls encoding processing in the encoding units 615 and 625. Specifically, for example, for encoding processing in the encoding units 615 and 625, the control unit 613 determines a picture type (e.g., the IDR picture type, P picture type, or B picture type) and issues an instruction indicating (designating) the determined picture type. Specifically, for example, the control unit 613 periodically (e.g., every 1 second) determines that the encoding is to be performed using the IDR picture type and issues an instruction for encoding using the IDR picture type to the encoding unit 615. Specifically, for example, the control unit 613 determines that encoding using the IDR picture type is to be performed at the time of starting or ending of zoom of the camera unit 612, at the time of starting or ending of pan of the camera unit 612, at the time of starting or ending of tilt of the camera unit 612, or at the time of starting or ending of autofocus of the camera unit 612 and issues an instruction for encoding using the IDR picture type to the encoding units 615 and 625. Specifically, for example, when a subject goes out of a frame of an image acquired by the camera unit 612 having a telephoto lens (i.e., when a subject is not shown in an acquired image), and the subject is in a frame of an image acquired by the camera unit 622 having a standard lens (or a wide-angle lens) (i.e., the subject is shown in an acquired image), the control unit 613 determines that the encoding is to be performed using the IDR picture type. Specifically, for example, when at least one of the lenses of the camera units 612 and 622 is covered by a photographing person, the control unit 613 determines that the encoding is to be performed using the IDR picture type. For example, the control unit 613 determines whether or not each of the lenses of the camera units 612 and 622 is covered by the photographing person, based on an acquired image.

Specifically, for example, the control unit 613 periodically (e.g., every 1 second) determines that the encoding is to be performed using the IDR picture type and issues an instruction for encoding using the IDR picture type to the encoding unit 625. Specifically, for example, the control unit 613 determines that the encoding is to be performed using the IDR picture type at the time of starting or ending of zoom of the camera unit 622, at the time of starting or ending of pan of the camera unit 622, at the time of starting or ending of tilt of the camera unit 622, or at the time of starting or ending of autofocus of the camera unit 622 and issues an instruction for encoding using the IDR picture type to the encoding unit 625 and the encoding unit 615.

Also, for example, upon determining that the image data acquired by the camera unit 612 is not to be encoded using the IDR picture type, the control unit 613 issues an instruction for encoding using the non-IDR picture type (the P picture type or B picture type) to the encoding unit 615. For example, upon determining that the image data acquired by the camera unit 622 is not to be encoded using the IDR picture type, the control unit 613 issues an instruction for encoding using the non-IDR picture type (the P picture type or B picture type) to the encoding unit 625. The control unit 613 is one example of a determining unit.

The operation unit 614 receives an input, performed by the user, for performing an operation on the image encoding apparatus 611, an operation on the camera units 612 and 622, data input to the image encoding apparatus 611, or the like. Examples of the operation unit 614 include a touch panel, a push-button, and a switch.

Based on the instruction from the control unit 613, the encoding unit 615 uses the predetermined coding system to encode un-compressed image data (a first input image) input from the camera unit 612. Specifically, for example, upon receiving the instruction for encoding using the IDR picture type from the control unit 613, the encoding unit 615 generates an IDR picture by using the predetermined coding system to perform intra-frame prediction encoding (intra-coding) on the un-compressed image data input from the camera unit 612. Also, for example, upon receiving the instruction for encoding using the non-IDR picture type from the control unit 613, the encoding unit 615 generates a P picture or B picture by using the predetermined coding system to perform inter-frame prediction encoding (inter-coding) on the un-compressed image data input from the camera unit 612. The encoding unit 615 then stores, in the storage unit 617, an encoded bit stream including the IDR picture, the P picture, and the B picture generated by the encoding.

Based on the instruction from the control unit 613, the encoding unit 625 uses the predetermined coding system to encode un-compressed image data (a second input image) input from the camera unit 622. Specifically, for example, upon receiving the instruction for encoding using the IDR picture type from the control unit 613, the encoding unit 625 generates an IDR picture by using the predetermined coding system to perform intra-frame prediction encoding (intra-coding) on the un-compressed image data input from the camera unit 622. Also, for example, upon receiving the instruction for encoding using the non-IDR picture type from the control unit 613, the encoding unit 625 generates a P picture or B picture by using the predetermined coding system to perform inter-frame prediction encoding (inter-coding) on the un-compressed image data input from the camera unit 622. The encoding unit 625 then stores, in the storage unit 617, video data (an encoded bit stream) including the IDR picture, the P picture, and the B picture generated by the encoding.

The predetermined coding system in the encoding units 615 and 625 is a coding system that can use the IDR picture type and is, for example, H.264 or H.265.

The storage unit 617 stores therein a program and data used by the image encoding apparatus 611, data generated by the image encoding apparatus 611, and so on. The storage unit 617 stores therein the video data (the encoded bit streams) generated by the encoding units 615 and 625. The storage unit 617 is, for example, a storage device, such as a flash memory or an HDD. The storage unit 617 may also be a portable recording medium, such as an SD memory card or a USB memory.

The image encoding apparatus 611 may further include a display unit that displays images acquired by the camera units 612 and 622 and the video data stored in the storage unit 617.

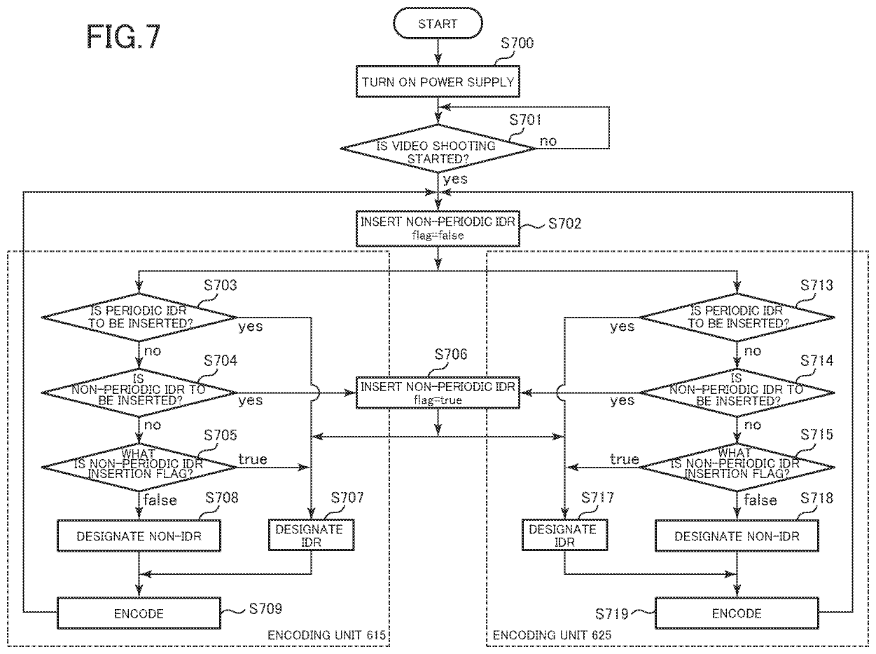

FIG. 7 is a flowchart illustrating one example of an image encoding method according to the second embodiment.

In step S700, a power supply of the image encoding apparatus 611 is turned on in accordance with a user's operation on the operation unit 614. In response, the camera units 612 and 622, the control unit 613, and so on start operations to allow video shooting.

In step S701, the control unit 613 determines whether or not video shooting is started. When the control unit 613 determines that video shooting is started, the control proceeds to step S702. For example, when a video shooting start operation is performed in accordance with the user's operation on the operation unit 614, the control unit 613 detects the video shooting start operation on the operation unit 614 (Yes in step S701), and controls the camera units 612 and 622 and the encoding units 615 and 625 to start the video shooting. Thus, the encoding units 615 and 625 start encoding using the predetermined coding system on respective pieces of un-compressed image data input from the camera units 612 and 622. The following description will be given of processing on images that are to be encoded (images to be encoded) by the corresponding encoding units 615 and 625, the images being included in the pieces of un-compressed image data (a plurality of first input images and a plurality of second input images) input to the encoding units 615 and 625.

In step S702, the control unit 613 sets false for a non-periodic IDR insertion flag indicating whether or not encoding using the non-periodic IDR picture type is to be performed on the images to be encoded. When the non-periodic IDR insertion flag is true, it indicates that encoding using a non-periodic IDR picture type is to be performed on the images to be encoded, and when the non-periodic IDR insertion flag is false, it indicates that encoding using the non-periodic IDR picture type is not to be performed on the images to be encoded. The non-periodic IDR insertion flag is stored in, for example, the control unit 613. The non-periodic IDR insertion flag may also be stored in the storage unit 617, a memory (not illustrated), or the like and be recorded thereto or read therefrom by the control unit 613, as appropriate.

After step S702, processes in steps S703 to S709 regarding control on the encoding in the encoding unit 615 (specifically, control on the picture type in the encoding in the encoding unit 615) and processes in steps S713 to S715, S706, and S717 to S719 regarding control on the encoding in the encoding unit 625 (specifically, control on the picture type in the encoding in the encoding unit 625) are executed in parallel. The following description will be given of details of the processes in steps S703 to S709 regarding control on the encoding in the encoding unit 615 (specifically, control on the picture type in the encoding in the encoding unit 615).

In step S703, the control unit 613 determines that the images to be encoded are to be encoded using the periodic IDR picture type. Specifically, for example, the control unit 613 determines that the image to be encoded is to be periodically (e.g., every 1 second) encoded using the IDR picture type. When the control unit 613 determines that the image to be encoded in the encoding unit 615 is to be encoded using the periodic IDR picture type (Yes in step S703), the control proceeds to step S707, and when the control unit 613 determines that the image to be encoded in the encoding unit 615 is not to be encoded using the periodic IDR picture type (No in step S703), the control proceeds to step S704.

In step S704, the control unit 613 determines that the image to be encoded is to be encoded using the non-periodic IDR picture type. For example, based on control on the camera unit 612 or the image acquired by the camera unit 612, the control unit 613 determines whether or not the encoding is to be performed using the non-periodic IDR picture type. Specifically, for example, the control unit 613 determines that the encoding is to be performed using the IDR picture type at the time of starting or ending of zoom of the camera unit 612, at the time of starting or ending of pan of the camera unit 612, at the time of starting or ending of tilt of the camera unit 612, or at the time of starting or ending of autofocus of the camera unit 612. Specifically, for example, when a subject goes out of a frame of an image acquired by the camera unit 612 having a telephoto lens, and the subject is in a frame of an image acquired by the camera unit 622 having a standard lens (or a wide-angle lens), the control unit 613 may determine that the encoding is to be performed using the IDR picture type. Also, specifically, for example, when at least one of the lenses of the camera units 612 and 622 is covered by a photographing person, the control unit 613 may determine that the encoding is to be performed using the IDR picture type. Specifically, for example, the control unit 613 may also determine that encoding using the IDR picture type is to be performed at the time of starting or ending of a section in which an input image is determined to have a good image composition, at the time of starting or ending of a section in which a subject in an input image speaks, or the like. When the control unit 613 determines that the encoding unit 615 is to perform encoding using the non-periodic IDR picture type (Yes in step S704), the control proceeds to step S706, and when the control unit 613 determines that the encoding unit 615 is not to perform encoding using the non-periodic IDR picture type (No in step S704), the control proceeds to step S705.

In step S705, the control unit 613 determines whether the non-periodic IDR insertion flag indicating whether or not the image to be encoded is to be encoded using the non-periodic IDR picture type is true or false. When the control unit 613 determines that the non-periodic IDR insertion flag is true, the control proceeds to step S707, and when the control unit 613 determines that the non-periodic IDR insertion flag is false, the control proceeds to S708.

In step S706, the control unit 613 sets true for the non-periodic IDR insertion flag indicating whether or not encoding using the non-periodic IDR picture type is to performed on the respective images to be encoded in the encoding units 615 and 625. In the control on the encoding in the encoding unit 615, after the process in steps S706, the control proceeds to step S707. The non-periodic IDR insertion flag is also used for controlling the encoding in the encoding unit 625, as described below, and when the non-periodic IDR insertion flag is true, the encoding unit 625 performs encoding using the IDR picture type on the image to be encoded, in accordance with an instruction from the control unit 613. Upon determining that the encoding unit 625 is to perform encoding using the non-periodic IDR picture type (Yes in step S714), the control unit 613 sets the non-periodic IDR insertion flag to true (step S706). As a result, in control (described below) on the encoding in the encoding unit 625, the control unit 613 determines that the non-periodic IDR insertion flag is true (true in step S715) and issues an instruction for encoding using the IDR picture type to the encoding unit 625 (step S717).

In step S707, the control unit 613 issues an instruction for encoding using the IDR picture type to the encoding unit 615 (“Designate IDR”).

In step S708, the control unit 613 issues an instruction for encoding using the non-IDR picture type (the P picture type or B picture type) to the encoding unit 615 (“Designate Non-IDR”).

In step S709, based on the instruction sent from the control unit 613 in step S707 or step S708, the encoding unit 115 uses the predetermined coding system (e.g., H.264 or H.265) to encode the un-compressed image data (the input image) input from the camera unit 612. Specifically, for example, upon receiving the instruction for encoding using the IDR picture type from the control unit 613, the encoding unit 615 generates an IDR picture by using the predetermined coding system to perform intra-frame prediction encoding (intra-coding) on the un-compressed image data input from the camera unit 612. Also, for example, upon receiving the instruction for encoding using the non-IDR picture type from the control unit 613, the encoding unit 615 generates a P picture or B picture by using the predetermined coding system to perform inter-frame prediction encoding (inter-coding) on the un-compressed image data input from the camera unit 612. Thereafter, the control returns to step S702, next un-compressed image data that is to be encoded after the image encoded in step S709 is set for a new image to be encoded, and the processes in steps S702 to S709 are repeated until there is no image data for an image to be encoded.

Since processes in steps S713 to S715, S706, and S717 to S719 regarding control on the encoding in the encoding unit 625 are substantially the same as processes in which the camera unit 612 and the encoding unit 615 are respectively replaced with the camera unit 622 and the encoding unit 625 in the above description of the processes in steps S703 to S709 regarding the control on the encoding in the encoding unit 615, detailed descriptions thereof are not given below. In the control on the encoding in the encoding unit 625, after the process in steps S706, the control proceeds to step S717.

According to the image encoding apparatus in the second embodiment, time points of non-periodic IDR pictures in video data encoded by the encoding unit 615 and time points of non-periodic IDR pictures in video data encoded by the encoding unit 625 can be made to match each other. This makes it easy to create a piece of video data in which time points are continuous before and after an edit point in edited video data, when pieces of video data are edited into the piece of video data by combining.

### (Implementation Examples Using Software)

Control blocks (particularly, the control units 113, 123, and 613, and the encoding units 115, 125, and 615) in the image encoding apparatuses 111, 121, and 611 may be implemented by logic circuits (hardware) formed in integrated circuit (IC) chips or the like or may be implemented by software using central processing units (CPU). In the latter case, the image encoding apparatuses 111, 121, and 611 each include a CPU that executes instructions from a program that is software for realizing the functions, a read-only memory (ROM) or a storage device (which are herein referred to as a “recording medium”) to which the program and various types of data are recorded so as to be readable by a computer (or a CPU), a random-access memory (RAM) to which the program is loaded, and so on. A computer (or a CPU) reads the program from the recording medium and executes it to thereby realize encoding that makes it easy to create video data in which time points are continuous before and after an edit point during editing without re-encoding. The recording medium can be implemented by a “non-transitory tangible medium”, for example, a tape, a disc/disk, a card, a semiconductor memory, a programmable logic circuit, or the like. The program may also be transmitted and supplied to the computer over an arbitrary transmission medium.

The present disclosure is not limited to the above-described embodiments, and modifications can be made thereto. The above-described configuration can also be replaced with substantially the same configuration, a configuration that offers the same advantages, or a configuration that can realize the same features.

For example, in the first embodiment, the encoding units 115 and 125 may make the determination as to whether or not encoding is to be performed using the IDR picture type. Also, for example, in the second embodiment, the processes in steps S703 to S709 regarding control on the encoding in the encoding unit 615 and the processes in steps S713 to S715, S706, and S717 to S719 regarding control on the encoding in the encoding unit 625 may be executed by respective different control units or may be executed by the respective encoding units 615 and 625. In such a case, when each control unit or each of the encoding units 615 and 625 determines that the encoding is to be performed using the IDR picture type, it transmits an instruction for encoding using the IDR picture type to the other control unit or the other encoding unit 625 or 615, as in the first embodiment. While there have been described what are at present considered to be certain embodiments of the present disclosure, it will be understood that various modifications may be made thereto, and it is intended that the appended claims cover all such modifications as fall within the true spirit and scope of the present disclosure.

The present disclosure contains subject matter related to that disclosed in Japanese Priority Patent Application JP 2020-026696 filed in the Japan Patent Office on Feb. 20, 2020, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image encoding apparatus that encodes a plurality of input images, the image encoding apparatus comprising:
a receiving unit that receives, from another image encoding apparatus, a first instruction for encoding using a type of reference picture that prohibits referencing to any reference image before the reference picture in inter-frame prediction encoding;
a determining unit that determines whether or not an image to be encoded, the image being included in the plurality of input images, is to be encoded using the reference picture type;
an encoding unit that generates a reference picture by using a predetermined coding system to perform intra-frame prediction encoding on the image to be encoded, when the receiving unit receives the first instruction, or when the determining unit determines that the image to be encoded is to be encoded using the reference picture type; and
a transmitting unit that transmits a second instruction for encoding using the reference picture type to the other image encoding apparatus, when the determining unit determines that the image to be encoded is to be encoded using the reference picture type.

2. The image encoding apparatus according to claim 1, further comprising:
a camera unit that captures the plurality of input images,
wherein the determining unit determines that the image to be encoded is to be encoded using the reference picture type at a time of starting or ending of zoom of the camera unit, at a time of starting or ending of pan of the camera unit, at a time of starting or ending of tilt of the camera unit, or at a time of starting or ending of autofocus of the camera unit.

3. The image encoding apparatus according to claim 1,
wherein the predetermined coding system comprises H.264/MPEG-4 AVC or H.265/MPEG-H HEVC, and
the reference picture comprises an instantaneous decoder refresh picture.

4. An image encoding apparatus that encodes a plurality of first input images and a plurality of second input images, the image encoding apparatus comprising:
a determining unit that determines whether or not a first image to be encoded, the first image being included in the plurality of first input images, is to be encoded using a type of reference picture that prohibits referencing to a reference image before the reference picture in inter-frame prediction encoding, and that determines whether or not a second image to be encoded, the second image being included in the plurality of second input images, is to be encoded using the reference picture type;
a first encoding unit that generates a reference picture by using a predetermined coding system to perform intra-frame prediction encoding on the first image to be encoded, when the determining unit determines that the first image to be encoded is to be encoded using the reference picture type, or when the determining unit determines that the second image to be encoded is to be encoded using the reference picture type; and
a second encoding unit that generates a reference picture by using a predetermined coding system to perform intra-frame prediction encoding on the second image to be encoded, when the determining unit determines that the second image to be encoded is to be encoded using the reference picture type, or when the determining unit determines that the first image to be encoded is to be encoded using the reference picture type.

5. The image encoding apparatus according to claim 4, further comprising:
a first camera unit that captures the plurality of first input images and a second camera unit that captures the plurality of second input images,
wherein the determining unit
determines that the first image to be encoded is to be encoded using the reference picture type at a time of starting or ending of zoom of the first camera unit, at a time of starting or ending of pan of the first camera unit, at a time of starting or ending of tilt of the first camera unit, or at a time of starting or ending of autofocus of the first camera unit, and
determines that the second image to be encoded is to be encoded using the reference picture type at a time of starting or ending of zoom of the second camera unit, at a time of starting or ending of pan of the second camera unit, at a time of starting or ending of tilt of the second camera unit, or at a time of starting or ending of autofocus of the second camera unit.

6. The image encoding apparatus according to claim 4,
wherein the predetermined coding system comprises H.264/MPEG-4 AVC or H.265/MPEG-H HEVC, and
the reference picture comprises an instantaneous decoder refresh picture.

7. An image encoding method for an image encoding apparatus that encodes a plurality of input images, the image encoding method comprising:
receiving, from another image encoding apparatus, a first instruction for encoding using a type of reference picture that prohibits referencing to any reference image before the reference picture in inter-frame prediction encoding;
determining whether or not an image to be encoded, the image being included in the plurality of input images, is to be encoded using the reference picture type;
generating a reference picture by using a predetermined coding system to perform intra-frame prediction encoding on the image to be encoded, when the first instruction is received, or when it is determined that the image to be encoded is to be encoded using the reference picture type; and
transmitting a second instruction for encoding using the reference picture type to the other image encoding apparatus, when it is determined that the image to be encoded is to be encoded using the reference picture type.

8. An image encoding method for an image encoding apparatus that encodes a plurality of first input images and a plurality of second input images, the image encoding method comprising:
determining whether or not a first image to be encoded, the first image being included in the plurality of first input images, is to be encoded using a type of reference picture that prohibits referencing to a reference image before the reference picture in inter-frame prediction encoding;
determining whether or not a second image to be encoded, the second image being included in the plurality of second input images, is to be encoded using the reference picture type;
generating a reference picture by using a predetermined coding system to perform intra-frame prediction encoding on the first image to be encoded, when it is determined that the first image to be encoded is to be encoded using the reference picture type, or when it is determined that the second image to be encoded is to be encoded using the reference picture type; and
generating a reference picture by using a predetermined coding system to perform intra-frame prediction encoding on the second image to be encoded, when it is determined that the second image to be encoded is to be encoded using the reference picture type, or when it is determined that the first image to be encoded is to be encoded using the reference picture type.
